(19) United States
(12) Patent Application Publication
(10) Pub. No.: US 2014/0117609 A1
(43) Pub. Date: May 1, 2014

(54) BANKNOTE COUNTING DEVICE

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: CHIH-KUN SHIH, Santa Clara, CA (US); WAN-CHENG LUO, Shenzhen (CN); XIAO-MAO XIE, Shenzhen (CN)

(21) Appl. No.: 13/931,457

(22) Filed: Jun. 28, 2013

(30) Foreign Application Priority Data
Oct. 26, 2012 (CN) 2012104153806

(51) Int. Cl. G07D 13/00

(52) U.S. Cl. CPC G07D 13/00
USPC 271/3.14

(57) ABSTRACT

A banknote counting device includes a banknote input mechanism, a banknote output mechanism, and an endless belt. The banknote input mechanism includes a banknote input shaft, a driving wheel, and a motor. The driving wheel rotates the banknote input shaft and the banknote input shaft itself rotates the banknote output mechanism via the endless belt, to utilize a single motor to drive both the input and output stages, and to ensure a constant and exact proportionality of speeds as between the input and output stages.

### BACKGROUND

1. Technical Field

The present disclosure relates to banknote counting structures, and more particularly to a banknote counting device with a simple structure.

2. Description of Related Art

Banknote counting devices are used in the finance industry. Usually, the banknote counting device includes a banknote input shaft and a banknote output shaft. The banknote input shaft and the banknote output shaft are driven by two separate motors, which is costly. Additionally, the banknote input shaft rotational speed may not synchronize with the banknote output shaft rotational speed, to cause miscounting and maybe loss of control of the banknote.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a banknote counting device in accordance with an embodiment.

FIG. 2 is an isometric view of a pinned sleeve of FIG. 1.

FIG. 3 is an assembled view of the banknote counting device of FIG. 1.

FIG. 4 is a cross-sectional view of the banknote counting structure, taken along the line IV-IV of FIG. 3, a motor not shown.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

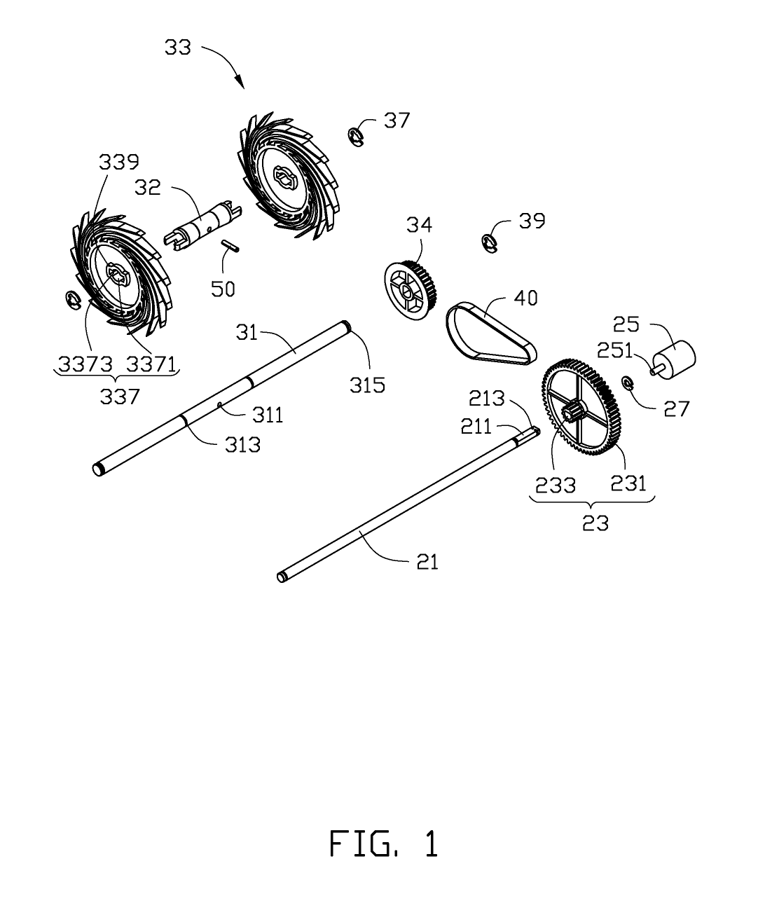

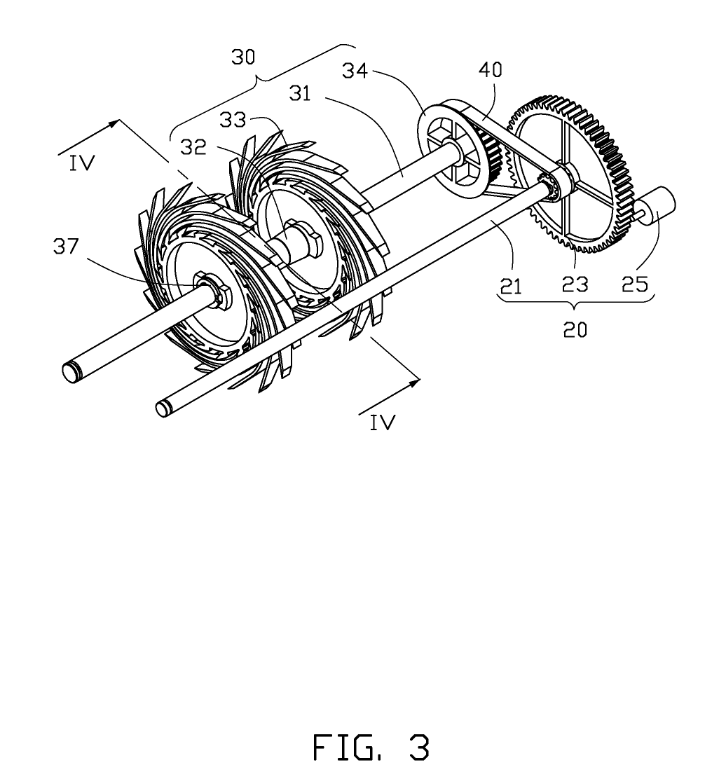

Referring to FIGS. 1 and 3, a banknote counting device in accordance with an embodiment includes a banknote input mechanism 20, a banknote output mechanism 30, and a endless belt 40 connecting the banknote input mechanism 20 and the banknote output mechanism 30.

The banknote input mechanism 20 includes a banknote input shaft 21, a driving wheel 23, and a motor 25. A locking portion 211 is located on an end of the banknote input shaft 21, for engaging with, and preventing slippage of, the driving wheel 23. A first circumferential slot 213 is defined in a distal end of the locking portion 211, for receiving a first snap ring 27. In one embodment, the banknote input shaft 21 is a substantially elongated rod, and the locking portion 211 cross-section is substantially semicircular.

The driving wheel 23 includes a first gear 231 and a second gear 233 integrated with the first gear 231. The first gear 231 has a first number of teeth, and the second gear 233 has a second number of teeth. The ratio between the first number of teeth and the second number of teeth is about 5:1. In one embodiment, the first number of teeth is about 60 in number, and the second number of teeth is about 12 in number. The motor 25 has a rotating shaft 251 with a plurality of teeth (not shown) meshing with the first gear 231.

The banknote output mechanism 30 includes a banknote output shaft 31, a pinned sleeve 32, two banknote counting wheels 33, and a driven wheel 34. The banknote output shaft 31 defines a securing hole 311 located on a middle portion of the banknote output shaft 31. Two second circumferential slot 313 are defined in the banknote output shaft 31 and located on two opposite sides of the securing hole 311, for receiving two second snap rings 37. A receiving slot 315 is defined in one end of the banknote output shaft 31, for reciving a third snap ring 39. In one embodiment, the banknote output shaft 31 is a substantially elongated rod.

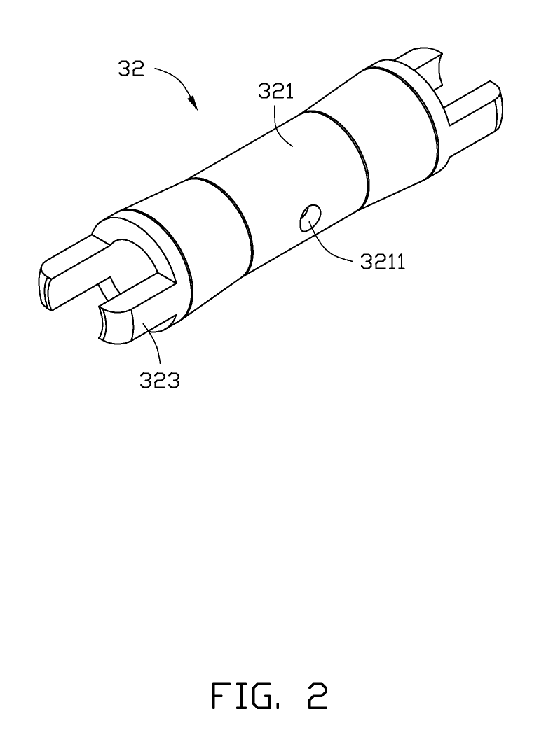

FIG. 2 shows that, the pinned sleeve 32 includes a sleeve portion 321 and two pairs of resilient prongs 323. The sleeve portion 321 surrounds the banknote output shaft 31 and defines a locking hole 3211 corresponding to the securing hole 311. The two pairs of resilient prongs 323 extend from two opposite ends of the sleeve portion 321 and engage with the two banknote counting wheels 33. Each of the two pairs of resilient prongs 323 maintain the same orientation in relation to each other.

The driven wheel 34 surrounds the banknote output shaft 31 and is engaged with the banknote output shaft 31, and has a third number of teeth. The ratio between the second number of teeth and the third number of teeth is about 3:1, and the ratio between the first number of teeth and the third number of teeth is about 5:3. In one embodiment, the third number of teeth is about 36 in number.

Each of the two banknote counting wheels 33 includes a rotating pan 331 and a plurality of banknote counting pieces 333 located on the periphery of the rotating pan 331. The rotating pan 331 defines an engaging hole 337 for receiving the banknote output shaft 31 and one pair of resilient prongs 323. The engaging hole 337 includes a wide portion 3371 and two narrow portions 3373 in communication with the wide portion 3371. Each pair of resilient prongs 323 extends through the two narrow portions 3373 to engage in the wide portion 3371. A flange 339 is located on the rotating pan 331, surrounding edges of the engaging hole 337 of each of the two banknote counting wheels 33.

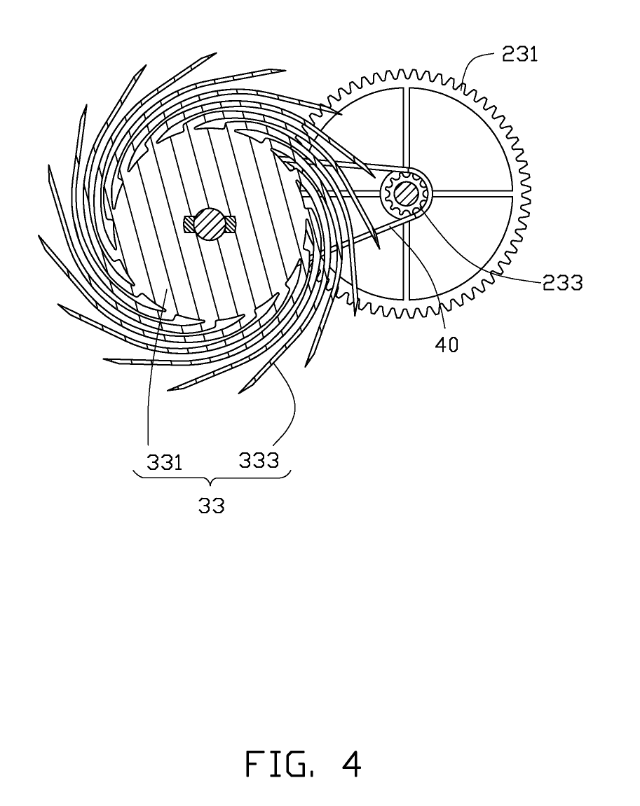

FIGS. 3 and 4 illustrate that, in assembly, the sleeve portion 321 of the pinned sleeve 32 is slid over the banknote output shaft 31, and the locking hole 3211 is aligned with the securing hole 311 of the banknote output shaft 31. A locking pin 50 is locked into the locking hole 3211 and the securing hole 311, to secure the pinned sleeve 32 to the banknote output shaft 31. Each of the banknote counting wheels 33 surrounds the banknote output shaft 31, and each of the two pairs of resilient prongs 323 are resiliently deformable for insertion into the two narrow portions 3373 of each of the two banknote counting wheels 33. Each of the two banknote counting wheels 33 is rotated about the banknote output shaft 31, until the two pairs of resilient prongs 323 are received in the narrow portion 3373 of each of the two banknote counting wheels 33. Each of the two pairs of resilient prongs 323 clips the banknote output shaft 31 in opposite directions and resists the flange 339. Each of the two second snap rings 37 is engaged in each of the two second circumferential slot 313 and abuts the flange 339 of each of the two banknote counting wheels 33, to prevent each of the two banknote counting wheels 33 from moving axially away from each other.

The driven wheel 34 surrounds one end of the banknote output shaft 31 and is engaged with it, thus the banknote output shaft 31 rotates with the driven wheel 34. The third snap ring 39 is engaged in the receiving slot 315 and abuts the driven wheel 34, to prevent the driven wheel 34 from disengaging from the banknote output shaft 31.

The driving wheel 23 surrounds the locking portion 211 of the banknote input shaft 21 and engages with the locking portion 211, thus the banknote input shaft 21 rotates with the driving wheel 23. The first snap ring 27 is engaged in the first circumferential slot 213 and abuts the first gear 231, to prevent the driving wheel 23 from disengaging from the locking portion 211. The rotating shaft 251 of the motor 25 is meshed with the first gear 231. The endless belt 40 surrounds the driven wheel 34 and the second gear 233 to require the rotation of both. The banknote counting device is secured to an enclosure in one embodiment.

In use, the motor 25 actuates the first gear 231 to rotate, and the second gear 233 rotates with the first gear 231. The first gear 231 rotates the banknote input shaft 21 to delivery a plurality of banknotes to the two banknote counting wheels 33. The second gear 233 rotates the driven wheel 34 via the endless belt 40. The driven wheel 34 rotates the banknote output shaft 31, and the two banknote counting wheels 33 rotate with the banknote output shaft 31, to count banknotes. Thus the banknote output shaft 31 is rotated by the driving wheel 23 without a motor, to save cost, and the endless belt 40 also rotates the banknote output shaft 31, at a speed which is in a constant and exact proportion of the speed of the banknote input shaft 21.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A banknote counting device comprising:
a banknote input mechanism comprising a banknote input shaft, a driving wheel, and a motor; the driving wheel is with the banknote input shaft and comprises a first gear and a second gear, integrated with the first gear; and the motor meshed with the first gear;
a banknote output mechanism comprising a banknote output shaft and a driven wheel engaged with the banknote output shaft; and
a endless belt surrounding the second gear and the driven wheel,
wherein the first gear is rotatable to rotate the banknote input shaft and the second gear driven by the motor, and the driven wheel is rotatable along the second gear by the endless belt to rotate the banknote output shaft.

2. The banknote counting device of claim 1, wherein the first gear has a first number of teeth, the second gear has a second number of teeth, the driven wheel has a third number of teeth, and the first number of teeth is greater than the second number of teeth and the third number of teeth.

3. The banknote counting device of claim 2, wherein a ratio between the first number of teeth and the second number of teeth is about 5:1, and a ratio between the second number of teeth and the third number of teeth is about 1:3.

4. The banknote counting device of claim 1, wherein a locking portion is located on one end of the banknote input shaft, and the locking portion surrounds the locking portion.

5. The banknote counting device of claim 4, wherein the locking portion has a cross-section, and the cross-section is substantially semicircular.

6. The banknote counting device of claim 5, wherein the banknote input shaft defines a first circumferential slot, the banknote input mechanism further comprises a first snap ring, and the first snap ring is engaged in the first circumferential slot and abuts the first gear.

7. The banknote counting device of claim 1, wherein the banknote output shaft further comprises a pinned sleeve and two banknote counting wheels, the pinned sleeve surrounds the banknote output shaft, and the two banknote counting wheels are engaged with the pinned sleeve and rotatable along with the banknote output shaft.

8. The banknote counting device of claim 7, wherein the pinned sleeve comprises a sleeve portion and two pairs of resilient prongs located on opposits ends of the sleeve portion, and the sleeve portion surrounds the banknote output shaft, and each of the two banknote counting wheels is engaged with each of the two pairs of resilient prongs.

9. The banknote counting device of claim 8, wherein each of the two counting wheels defines an engaing hole, and the engaing hole comprises a wide portion and two narrow portions in communication with the wide portion; and each of the two pairs of resilient prongs extend through the two narrow portions to be engaged in the wide portion of each of the two counting wheels.

10. The banknote counting device of claim 8, wherein the sleeve portion defines a locking hole, and the banknote output shaft defines a securing hole, and a locking pin is locked into the locking hole and the securing hole, to secure the pinned sleeve to the banknote output shaft.

11. A banknote counting device comprising: <fix the rest like above>
a banknote input mechanism comprising a banknote input shaft, a driving wheel, and a motor; the driving wheel engaged with the banknote input shaft, and the motor meshed with the driving wheel;
a banknote output mechanism comprising a banknote output shaft and a driven wheel engaged with the banknote output shaft;
a endless belt connecting the driving wheel with the driven wheel,
wherein the driving wheel is rotatable to rotate the banknote input shaft driven by the motor, and the driven wheel is rotatable along the driving wheel by the endless belt to rotate the banknote output shaft.

12. The banknote counting device of claim 11, wherein the driving wheel comprises a first gear and a second gear integrated with the first gear, the motor meshed with the first gear, and the endless belt surrounds the driven wheel and the second gear.

13. The banknote counting device of claim 12, wherein the first gear has a first number of teeth, the second gear has a second number of teeth, the driven wheel has a third number of teeth, and the first number of teeth is greater than the second number of teeth and the third number of teeth.

14. The banknote counting device of claim 13, wherein a ratio between the first number of teeth and the second number of teeth is about 5:1, and a ratio between the second number of teeth and the third number of teeth is about 1:3.

15. The banknote counting device of claim 11, wherein a locking portion is located on one end of the banknote input shaft, and the locking portion surrounds the locking portion.

16. The banknote counting device of claim 15, wherein the locking portion has a cross-section, and the cross-section is substantially semicircular.

17. The banknote counting device of claim 16, wherein the banknote input shaft defines a first circumferential slot, the banknote input mechanism further comprises a first snap ring, and the first snap ring is engaged in the first circumferential slot and abuts the first gear.

18. The banknote counting device of claim 11, wherein the banknote output shaft further comprises a pinned sleeve and two banknote counting wheels, the pinned sleeve surrounds the banknote output shaft, and the two banknote counting wheels are engaged with the pinned sleeve and rotatable along with the banknote output shaft.

19. The banknote counting device of claim 18, wherein the pinned sleeve comprises a sleeve portion and two pairs of resilient prongs located on opposits ends of the sleeve portion, and the sleeve portion surrounds the banknote output shaft, and each of the two banknote counting wheels is engaged with each of the two pair of resilient prongs.

20. The banknote counting device of claim 19, wherein each of the two counting wheels defines an engaing hole, and the engaing hole comprises a wide portion and two narrow portions in communication with the wide portion, each of the two pairs of resilient prongs extend through the two narrow portions to be engaged in the wide portion of each of the two counting wheels.
